(19) United States
(12) Patent Application Publication
(10) Pub. No.: US 2010/0224798 A1
(43) Pub. Date: Sep. 9, 2010

(54) SCINTILLATOR BASED ON LANTHANUM IODIDE AND LANTHANUM BROMIDE

(75) Inventors: Pieter Dorenbos, GM Rijswijk (NL); Muhammad D. Birowosuto, Jakarta (ID); Karl W. Kraemer, Berne (CH); Hans-Ulrich Guedel, Thoerishaus (CH)

Correspondence Address: LARSON NEWMAN & ABEL, LLP, 5914 WEST COURTYARD DRIVE, SUITE 200, AUSTIN, TX, 78730, US

(73) Assignees: STICHTING VOOR DE TECHNISCHE WETENSCHAPPEN, JP Utrecht (NL); UNIVERSITE DE BERNE, Berne (CH)

(21) Appl. No.: 12/558,373

(22) Filed: Sep. 11, 2009

Related U.S. Application Data
(60) Provisional application No. 61/096,248, filed on Sep. 11, 2008.

(51) Int. Cl. H05B 33/14; G01T 1/20; C09K 11/61

(52) U.S. Cl. 250/484.2; 252/301.4 H

(57) ABSTRACT

A scintillator material has a formula La₍₁₋ₓ₎CeₓBr_{3(1-y)}I_{3y} in which x represents a real number greater than or equal to 0.0005 and less than 1, y represents a real number greater than 0.20 and equal to or less than 0.9. This material has scintillation properties and emission properties and is useful in a scintillation-based detector for detecting radiation over a wide energy range.

### CROSS-REFERENCE TO RELATED APPLICATIONS

The present application claims priority from U.S. Provisional Patent Application No. 61/096,248, filed Sep. 11, 2008, entitled “SCINTILLATOR BASED ON LANTHANUM IODIDE AND LANTHANUM BROMIDE,” naming inventors Pieter Dorenbos, Muhammad D. Birowosuto, Karl. W. Kraemer and Hans-Ulrich Guedel, which application is incorporated by reference herein in its entirety.

### BACKGROUND

1. Field of the Invention

The invention relates to a novel type of scintillating material comprising a doped halide.

2. Related Art

Lanthanum halides in general have good scintillation properties, enabling them to be used as scintillating materials for the manufacture of detectors operating by scintillation. Such detectors are widely used for the detection of gamma rays, X-rays and high-energy cosmic rays, and also for the detection of charged particles. Scintillation-based detectors may be used within a wide energy range, typically between 1 keV and 10 MeV, or even, in some applications, at even higher energies.

A scintillation-based detector comprises a scintillating material that converts absorbed high-energy photons or particles into ultraviolet (UV), visible spectrum or infrared (IR) photons. These UV, visible or IR photons are then converted into an electrical signal by means of a photon collector incorporated into the detector.

Scintillating materials may vary in form: single crystal, ceramic, glass, glass-ceramic, plastic, or even liquid. The single-crystal form is particularly advantageous since, compared with a polycrystalline material, which has many grain boundaries and defects that scatter light, a single crystal maintains better transparency even for large thicknesses. Consequently, extraction of the UV, visible or IR photons is much more effective. Likewise, compared with glasses, the organization of the crystal lattice in single crystals permits better efficiency of converting the incident radiation into UV, visible or IR photons.

The photon collectors used to convert the UV, visible or IR photons into electrical signals may also be of several types. For example, photon collectors can be made of photomultiplier tubes, or various kinds of photodiodes.

A good scintillation material is characterized in particular by a high light yield (expressed as photons/MeV; the higher the efficiency, the more luminous the material), a very fine energy resolution (expressed as a percentage at a given energy and calculated from the mid-height width of the peak with respect to the position of its centroid; the better the resolution, the smaller the percentage) and a short scintillation lifetime (expressed by a time constant, called the decay time: the shorter this constant, the more rapid the scintillation). A need exists to continue improving scintillating materials.

### DETAILED DESCRIPTION OF EMBODIMENTS

In accordance with an embodiment, particular ranges of compositions having relatively high LaI₃ content in a LaBr₃+LaI₃ system, makes it possible to obtain homogeneous materials having particularly effective scintillation properties at room temperature. In some embodiments, the compositions having LaI₃ contents between 20 and 90 mol %, and in other embodiments between 45 and 55 mol % exhibit very high scintillation properties, superior to what was previously known in the case of mixtures containing LaI₃. In a particular embodiment, the LaBr₃+LaI₃ system can be substantially free of LaCl₃.

Before proceeding further, a better understanding of conventional lanthanum halides is presented. Certain cerium-doped lanthanum halides are known for their scintillation properties. Cerium-doped LaBr₃ compositions, as described in International Application WO 01/60945, have good scintillating properties in terms of light yield, energy resolution and temporal properties. As an example of this family of scintillating materials, LaBr₃ single crystal doped with 5 mol % Ce exhibits properties with an energy resolution of 2.6% for an excitation energy of 662 keV (¹³⁷Cs main emission), a light yield of 70 000 photons per MeV and a scintillation decay time of 16 ns according to K. Krämer et al. (“Development and characterization of highly efficient new cerium doped rare earth halide scintillator materials”, J. Mater. Chem., 2006, 16, pp. 2773-2780). Likewise, cerium-doped LaCl₃ materials as described in International Application WO 01/60944 are also good scintillators with, however, a slightly inferior performance in terms of light yield and resolution than bromide materials.

Cerium-doped lanthanum iodide compositions differ markedly from bromides or chlorides from the standpoint of their scintillation properties. Specifically, Ce-doped LaI₃ has a very low scintillation at room temperature, making it unusable for radiation detection applications such as those described above. A. Bessiere et al. (“Luminescence and scintillation properties of the small bandgap compound LaI₃:Ce³⁺”, Nuclear Instruments and Methods in Physics Research, Section A 537, 2005, pp. 22-26) gives the scintillation properties as a function of the temperature of an LaI₃ single crystal doped with 0.5 mol % cerium and excited by X-rays. By raising the temperature, the light yield decreases very strongly and, above 200 K (−73° C.), this becomes very low with only a few hundred photons per MeV. The very low scintillation of cerium-doped LaI₃ above 200 K is explained by the organization of the various energy levels in the material, in particular the fact that the 5d energy level of cerium in this matrix is very close to the conduction band of the material. Specifically, the rapid scintillation of cerium essentially takes place by the transition of an electron from the 5d energy level of cerium to the 4f energy level of cerium. In the particular case of Ce-doped LaI₃, a 5d electron jumps into the conduction band by thermal activation, making the scintillation in cerium practically zero. The thermal activation may be appreciably reduced by keeping the material at very low temperature. However, this solution is not applicable within the context of the normal use of a scintillation-based detector (typically between 4° C. and 43° C. for conventional applications and between −20° C. and 175° C. for certain special applications).

However, mixtures of compounds having different crystal structures and/or anions of different ionic radius generally cause a problem because it is not generally possible to mix the constituents in large proportions in respect of each of them. In particular, a large radius difference will induce large strains in the crystal lattice that not only make mixtures with high contents impossible but also cause fracturing when pulling single crystals owing to the mechanical stresses induced in the crystal lattice.

Particular rare-earth bromides and chlorides possess identical crystal structures and mixtures of these, materials of this type have been produced. US 2005/0082484 and U.S. Pat. No. 7,202,477 disclose materials composed of a cerium-doped LaCl₃/LaBr₃ mixture or a CeCl₃/CeBr₃ mixture respectively. Now, LaCl₃, LaBr₃, CeCl₃ and CeBr₃ all have the same P6₃/m hexagonal crystal structure and mixtures having high contents have been produced (for example: Ce(Cl_{0.5}Br_{0.5})₃ (50 mol % mixture) or La(Cl_{0.66}Br_{0.34})₃ (34 mol % mixture).

However, in the case of LaI₃ and LaBr₃, the difference in ionic radii of the anions is greater, and the respective crystallographic structures are very different (LaBr₃ has a P6₃/m hexagonal structure while LaI₃ has a Cmcm orthorhombic structure). There is a priori a high risk of phase separation, which would lead to the formation of an inhomogeneous material with a very detrimental effect on the scintillation properties. This is why only examples of crystals produced with small additions of one compound in the other are found in the literature. Thus, J. Glodo et al. (“Scintillation properties of some Ce-doped mixed lanthanum halides”, Proceedings of the 8th International Conference on Inorganic Scintillators and their Use in Scientific and Industrial Applications (SCINT 2005), Alushta (Crimea, Ukraine), ISBN 9666-02-3884-3, pp. 118-120) only studies LaBr₃/LaI₃ mixed compositions with LaI₃ content of less than 20 mol %. Within the context of this study, an LaBr_{2.4}O_{0.6} polycrystalline specimen doped with 1 mol % cerium has a light yield of 24 100 photons/MeV, an energy resolution of 7% under excitation at 662 keV (¹³⁷Cs source) and a maximum scintillation decay time of 28 ns.

Patent Application US 2005/0082484 (U.S. '484) discloses mixtures of LaBr₃+LaCl₃, and LaI₃-based compositions, with a mention of mixed halides containing LaI₃. U.S. '484 makes reference to wide substitutional ranges of LaI₃ for the other halide species (e.g., 0.1 to 99 mol % substitutional). U.S. '484 does not recognize the significance of particular subsitutional ranges of LaI₃ nor have examples in this respect.

According to particular embodiments of the present invention, a light yield of greater than 50 000 photons/MeV can be obtained. Similarly, a scintillation decay time of of less than 35 ns can be obtained, with examples at 12 ns, that is to say more rapid than the scintillation decay time for LaBr₃ doped with 5 mol % cerium.

Other particular embodiments described herein provide exceptional properties related to emission wavelength, enabling usage of materials in applications such as use with Si-based photosensors. In one embodiment, the scintillator material has an emission wavelength greater than 400 nm, and in another embodiment, an emission wavelength is greater than 420 nm. In a further embodiment, an emission wave length is greater than 440 nm, and in still a further embodiment, an emission wavelength is greater than 460 nm. Particular examples achieve an emission wavelength (peak) of about 470 nm. The foregoing emission levels should be contrasted with those associated with prior art LaBr/C1 materials, having emission wavelengths below 400 nm. For example, LaBr₃:Ce has an emission wavelength of 370 nm. Accordingly, particular embodiments herein have been found to offer exceptional emission properties combined with desirable scintillation properties. Unless otherwise noted, the term ‘emission wavelength’ refers to the wavelength of the corresponding maximum (peak) output across the detectable emission range of the material.

Compositions can may be described by the formula:

—La₍₁₋ₓ₎CeₓBr_{3(1-y)}I_{3y} (1)

in which:
x represents a real number equal to or greater than 0.0005 and less than 1; and
y represents a real number greater than 0.20 and equal to or less than 0.9.

In one embodiment, x ranges from 0.001 to 0.5, and in another embodiment, from 0.005 to 0.2.

In one embodiment, y ranges from 0.45 to 0.55. In this particular range for y, the light yield may be greater than 50 000 photons/MeV, and the scintillation decay time may be less than 35 ns.

Cerium (in halogenated form in the crystal) can be the dopant element, and x can be the level of doping, which may also be expressed as a molar percentage (e.g. 10% doping corresponds to x=0.1).

A scintillator material, having the composition described by formula (1), may also contain impurities. These impurities may derive from the raw materials or may be introduced by the production process. Typically, the total level of impurities in the material is less than 0.1 wt % and more frequently less than 0.01 wt %. LaCl₃ may form part of these impurities. In a particular embodiment, the scintillator material is substantially free of LaCl₃.

Examples of particular compositions include:
LaBr_{1.5}I_{1.5} doped with 0.1 to 50 mol % cerium (i.e., x=0.001 to 0.5 and y=0.5 in the formula);
LaBr_{2.25}I_{0.75} doped with 0.1 to 50 mol % cerium (i.e., x=0.001 to 0.5 and y=0.25 in the formula); and
LaBr_{0.3}I_{2.7} doped with 0.1 to 50 mol % cerium (i.e., x=0.001 to 0.5 and y=0.90 in the formula).

The emission wavelength, the light yield and the scintillation decay time of the material vary depending on the proportion of LaBr₃ and LaI₃ in the mixture. As LaI₃ content is increased, the emission wavelength may shift towards long wavelengths, up to a point. Unexpectedly, when the scintillator material has around 50 mol % LaI₃ (i.e. y=0.5), the emission wavelength may become largely independent of the LaI₃ content, and remains at about 470 nm.

Scintillation properties, such as the light yield and the scintillation decay time, are possessed by particular embodiments. For example, an embodiment according to the invention having 50 mol % LaI₃ (i.e. y=0.5) has been measured to have a light yield of 58 000 photons/MeV; embodiments having contents of 25 mol % LaI₃ (i.e. y=0.25 and 67 mol % LaI₃ (i.e. y=0.67) have luminous efficiencies of 45 000 photons/MeV and 22 000 photons/MeV respectively. Embodiments having 75 mol % LaI₃ (i.e. y=0.75) have a scintillation decay time of 12 ns, embodiments having 50 mol % LaI₃ has a scintillation decay time of 28 ns.

### EXAMPLES

Single crystals corresponding to formula 1 above were manufactured by the Bridgman method, by melting the corresponding simple halides. Table 1 gives their scintillation properties at room temperature.

TABLE 1

| | | | | Scintillation |
|---|---|---|---|---|
| | y | x | Light | decay |
| | (LaI₃ content | (cerium doping | yield | time |
| Example | in formula 1) | in formula 1) | (ph/MeV) | (ns) |
| Ex 1 | 0.25 | 0.05 | 45000 | 31-244 |
| Ex 2 | 0.5 | 0.05 | 58000 | 28 |
| Ex 3 | 0.67 | 0.05 | 22000 | 12.5 |
| Ex 4 | 0.75 | 0.05 | 25000 | 12 |

1. A scintillator material of formula La₍₁₋ₓ₎CeₓBr_{3(1-y)}I_{3y} in which:
x represents a real number equal to or greater than 0.0005 and strictly less than 1; and
y represents a real number strictly greater than 0.20 and equal to or less than 0.9.

2. The scintillator material according to claim 1, characterized in that x is greater than or equal to 0.001 and less than or equal to 0.5.

3. The scintillator material according to claim 1, characterized in that x is greater than or equal to 0.005 and less than or equal to 0.2.

4. The scintillator material according to claim 1, characterized in that y is greater than or equal to 0.45 and less than or equal to 0.55.

5. The scintillator material according to claim 1, characterized in that the scintillator material is substantially free of LaCl₃ and contains less than 0.1 wt % of impurities.

6. The scintillator material according to claim 1, characterized in that the scintillator material is a single crystal.

7. The scintillator material according to claim 6, characterized in that x ranges from 0.005 to 0.2 and y ranges from 0.45 to 0.55.

8. The scintillator material according to claim 7, characterized in that a light yield of the scintillator material is greater than 50 000 photons/MeV, and a scintillation decay time of the scintillator material is less than 35 ns.

9. A scintillation-based detector comprising a material according to claim 8 and a photon collector.

10. A scintillation-based detector comprising a material according to claim 7 and a photon collector.

11. A scintillation-based detector comprising the scintillator material according to claim 1 and a photon collector.

12. The scintillation material according to claim 1, characterized in that a peak emission wavelength of the scintillator material is not less than 400 nm.

13. The scintillation material according to claim 1, characterized in that a peak emission wavelength of the scintillator material is not less than 420 nm.
